(19) United States
(12) Patent Application Publication
(10) Pub. No.: US 2020/0113395 A1
(43) Pub. Date: Apr. 16, 2020

(54) WATERLESS WATER CLOSET IN A MOTORHOME

(71) Applicant: CLOSAC AG, Grabs (CH)

(72) Inventor: Rainer BUCK, Wangen (DE)

(73) Assignee: CLOSAC AG, Grabs (CH)

(21) Appl. No.: 16/658,737

(22) Filed: Oct. 21, 2019

Related U.S. Application Data
(63) Continuation of application No. PCT/EP2018/058533, filed on Apr. 4, 2018.

(30) Foreign Application Priority Data
Apr. 21, 2017 (DE) 10 2017 108 556.4

(51) Int. Cl. A47K 11/02; B60R 15/04

(52) U.S. Cl. CPC A47K 11/026; B60P 3/32; B60R 15/04

(57) ABSTRACT

The present invention relates to a motorhome, mobile home or similar travelling or recreational vehicle comprising at least one sanitary area in which a water closet device is mounted. The water closet device comprises at least one seat element and is connected to a current source which carries out a waterless flush operation.

### CROSS REFERENCE TO RELATED APPLICATIONS

This application is a continuation of International Application No. PCT/EP2018/058533 filed Apr. 4, 2018, which designated the United States, and claims the benefit under 35 USC § 119(a)-(d) of German Application No. 10 2017 108 556.4 filed Apr. 21, 2017, the entireties of which are incorporated herein by reference.

### FIELD OF THE INVENTION

The present invention relates to a motorhome, caravan or similar travel or recreational vehicle.

### BACKGROUND OF THE INVENTION

Motorhomes or caravans, etc. are well known from the prior art. Such travel or recreational vehicles conventionally comprise, in addition to a living region, a sanitary region in which, inter alia, a toilet is also arranged.

A disadvantage in this connection is the use of water for flushing the toilet after it has been used. For this purpose, water is required for the flushing, i.e. for eliminating excrement or similar excretions from the toilet, the water having to be carried along in tanks. The additional load resulting therefrom may involve an increased stowage space and fuel consumption. In addition, corresponding collecting tanks which receive the used flushing water are required. A further disadvantage in this regard is that flushing water which has just been used may have very bad odor. Finally, the use of water for flushing in toilet devices is also not without problems in an ecological respect.

### SUMMARY OF THE INVENTION

It is the object of the present invention to eliminate the disadvantages mentioned at the beginning.

In order to achieve the object, a motorhome, caravan or similar travel or recreational vehicle is provided, comprising at least one sanitary region in which a toilet device is arranged, wherein the toilet device comprises at least one seat element.

It is essential for the present invention that the toilet device is connected to a current source by which a water-free flushing operation can be carried out.

A toilet device of this type does not require any water reserves for eliminating excrement or similar excretions. It is, thus, possible to dispense with carrying along water separately for flushing the toilet. Further stowage space is, therefore, available which can be used instead of the water provided for flushing the toilet device. The omission of carrying along water for flushing the toilet device also makes it possible to reduce the load, and therefore, in some circumstances, fuel can be saved. Saving on water for flushing the toilet device is also beneficial for environmental protection. Water-free flushing, i.e. water-free elimination of excrement or similar excretions, also has the advantage that no special cleaning chemicals have to be carried along and used, and, therefore, a cost saving can result and a further contribution to environmental protection can be made.

A particularly preferred refinement of the present invention can make provision for the toilet device to comprise at least one collecting element. A particularly hygienic toilet device can thereby be provided.

In an advantageous refinement of the present invention, it can be provided that the toilet device comprises at least one container by which excrement or similar excretions can be transferred into the collecting element.

Excrement or similar excretions can, thereby, be eliminated completely and, in particular, without leaving behind traces. The use of a container can also be advantageous in order to counteract negative odors caused by the excrement or other excretions.

In a further advantageous refinement of the present invention, it can be provided that the toilet device comprises at least one closing mechanism of which the at least one container can be closed. A closable container prevents the emergence of excrement, urine or similar excretions. A closable container can also be transported away particularly simply and, in addition, can counteract odors.

A further refinement of the present invention can make provision for the toilet device to comprise at least one heating element. The container can, thereby, be closed by a material bond by means of heat. Closing of this type may also be regarded as bonding. The container can, thereby, be highly reliably permanently closed. This can also prevent excrement or similar excretions from being able to emerge from the container. It is, therefore, possible to prevent a user from being able to come into direct contact with excretions, etc.

In a further refinement, the present invention can make provision for the at least one heating element and the at least one closing mechanism to be designed as an integral assembly.

Such an assembly can permit a particularly compact overall size of the toilet device, as a result of which the latter can be manufactured in a highly space-saving manner. This can have a positive effect on the layout planning of motorhomes, caravans, etc. An advantageous development of the present invention can make provision for the toilet device to comprise at least one conveying mechanism. A conveying mechanism can permit, for example, conveying of a container which is or has been filled with excrement or similar excretions. This, therefore, constitutes a simple possibility of transporting away such a container in a simple manner.

In an advantageous refinement, the present invention can make provision for the toilet device to comprise at least one optoelectrical system which is preferably arranged in the seat element below a closing mechanism arranged in the seat element.

This makes it possible for, for example, objects to be detected within a container. Particularly reliable functioning of the toilet device can, therefore, be made possible. Furthermore, it can be made possible, in particular, that no objects, in particular, excrement or similar excretions, can emerge from the container or can project beyond a closure region. Furthermore, a user can be prevented from coming into direct contact with excrement or similar excretions.

A further advantageous development of the present invention can make provision for the closing mechanism to comprise at least two holding mechanisms. Reliable closing of a container can, thereby, be made possible.

The present invention can make provision for the current source to be electrically connected to the closing mechanism and/or to the heating element. This permits reliable operability and, therefore, reliable elimination of excrement or other excretions.

A development of the present invention can make provision for the closing mechanism and/or the heating element to be designed as a separating mechanism. In an advantageous manner, no further components are, therefore, required in order to eliminate a container which has been filled, for example, with excrement.

The present invention can make provision for the closing mechanism and/or the heating element to be designed as a separating mechanism for the container which is preferably manufactured from a plastic and is designed, in particular, as a film tube. A container filled with excrement can be detached in a simple manner by a separating mechanism.

The present invention can make provision in a preferred refinement for the heating element to be designed as a closing mechanism and as a separating mechanism. Closing of the container and detaching of the container, for example, from a further unused container, can, therefore, be made possible by use of a component.

In an advantageous refinement of the present invention, it can, therefore, be provided that the container is manufactured from a plastic and is designed, in particular, as a film tube.

Components of this type which are manufactured from plastic have sufficiently high stability, and, therefore, an unintentional emergence of excrement from a container can be prevented. In addition, containers in the form of film tubes can be produced cost-effectively. Furthermore, film tubes can permit a multiplicity of successive uses of the toilet device. A reduced weight of the film tubes in relation to water, which is used for flushing in toilet devices from the prior art, should also be considered an advantage here.

In addition, an advantageous refinement of the present invention can make provision for the seat element to be designed as a receiving mechanism for the at least one container. This is a particularly space-saving possibility of providing a container for excrement, excretions, etc.

In an advantageous development of the present invention, it can be provided that the toilet device comprises at least one sensor. This can significantly increase the reliability of the toilet device. It can especially be ensured that a user of the toilet device cannot come into direct contact with excrement, excretions, etc. after a flushing operation since the sensor can sense whether excrement is completely located in a container and whether the flushing operation has, therefore, fully taken place. A particularly hygienic toilet device can also be provided as a result.

It is particularly advantageous if the at least one sensor is arranged in such a manner that objects, for example, excrement or similar excretions, which are arranged within the container can be detected. The present invention can preferably make provision for the at least one sensor to be designed as an image capture device, for example, camera, or as an image sensor. In addition, sensors of this type are obtainable cost-effectively.

This can permit, particularly, reliable functioning of the toilet device since it can optionally be detected and, in particular, prevented that excrement can emerge from the container after a flushing operation, i.e. after closing of the container. Furthermore, it is possible to detect or sense whether excrement is arranged in a container in such a manner that the excrement is arranged in a closing region when the container is closed. It is, therefore, also possible to provide a toilet device which provides a high degree of hygiene since it is possible, in particular, to avoid excrement being incompletely arranged within the container or a flushing operation taking place incompletely.

In a further advantageous refinement of the present invention, it can be provided that the seat element is rotatable in relation to the collecting element.

A particularly space-saving possibility of using the toilet device is, therefore, provided in a structurally simple manner. This also permits the provision of a toilet device which is usable flexibly in respect of different room configurations.

In addition, an advantageous refinement of the present invention can make provision for the toilet device to comprise at least one control unit and an actuating mechanism, wherein the control unit is electrically connected to the actuating mechanism and to the current source.

This firstly permits particularly convenient operation of the toilet device. Secondly, a control unit can make it possible for excrement to be able to be reliably enclosed, for example, in a container by control of the components, which are arranged in the toilet device, for carrying out a flushing operation, for example, closing mechanism and/or a heating element and/or a separating mechanism. A particularly hygienic toilet device can, therefore, be provided.

Within the context of the present invention, it can also be provided that the control unit is electrically connected to the heating element and/or to at least one closing mechanism and/or to a sensor and/or to an optoelectrical system. The toilet device can, therefore, be reliably operated by control of the closing mechanism and/or of the sensor and/or of the optoelectrical system. It is possible, in particular, by such a control to avoid incomplete flushing operations being able to take place. A particularly hygienic toilet device is thereby provided.

A further refinement of the present invention can make provision for the sanitary region to comprise at least one cupboard, wherein the toilet device is arranged in the cupboard. This constitutes a further particularly space-saving accommodating of a toilet device in a motorhome, caravan, etc. The present invention can furthermore make provision for the toilet device to be arranged extendibly in a cupboard. This constitutes a simple possibility of being able to rapidly use the toilet device when required.

In a further advantageous refinement of the present invention, it can be provided that the toilet device comprises at least one movement mechanism by which the toilet device is movable in a vertically displaceable manner. In an advantageous manner, individual needs of users, for example, adults and children, etc., can be taken into consideration.

In addition, the present invention can make provision for the toilet device to be pivotable in relation to the movement mechanism. Further individual needs of users can, thereby, also be taken into consideration. It can also be made possible for the toilet device to be able to be arranged in a particularly space-saving manner in a motorhome, caravan, etc.

The present invention can also make provision for the toilet device to comprise at least one energy store. A particular advantage of this is that the toilet device itself can be used if the current source is at least temporarily not available. Use of the toilet device is also possible, for example, if the motorhome or the caravan, etc. is located far away from a power supply, in particular, in a driving mode.

In a refinement of the present invention, it can, therefore, be provided that the current source is designed as an energy store, in particular, accumulator. In an advantageous manner, the toilet device can be operated independently of a power supply. An energy store can therefore permit increased flexibility in respect of the use of the toilet device.

In a further refinement of the present invention, it can be provided that the toilet device comprises a cover, wherein the cover comprises at least one sensor. A cover can protect the toilet device from damage. It is also possible, for example, to prevent objects from unintentionally entering the toilet device, by the toilet device being closed by the cover. A closed cover can also counteract the escape of unpleasant odors from the toilet device.

A sensor which is arranged in the cover can permit reliable functioning of the toilet device. For example, it can be determined whether excrement is fully arranged within a container and cannot escape or emerge from the latter such that a user can come into direct contact with such excrement.

Furthermore, the present invention can make provision for the collecting element to comprise a drawer, wherein the collecting element or the drawer comprises at least one sensor. A drawer enables, for example, containers which are located therein and have been filled with excrement or similar excretions, to be removed in a particularly simple manner. A drawer which comprises a sensor can increase the reliability of the toilet device by, for example, the operation of the toilet device being prevented if the drawer is not or is not correctly arranged in the toilet device or in the collecting element.

The present invention can also make provision for the toilet device to comprise at least one sound generator which is preferably arranged in the seat element.

An acoustic warning signal, for example, can be output by a sound generator should an insufficient quantity of containers or no containers at all be available. The reliability of the toilet device can thereby be increased. Such a sound generator can be designed, for example, as a loudspeaker or buzzer.

Within the context of the present invention, water-free flushing can be understood as meaning elimination of excrement or similar excretions by transfer of same into a container and closing of the container by electrical current.

The present invention can also make provision for the toilet device to comprise a safety switch. Immediate switching off of the toilet device can therefore be made possible, for example, in emergency situations. A toilet device of this type has an increased degree of safety.

### BRIEF DESCRIPTION OF THE DRAWINGS

The present invention will be explained in more detail below with reference to drawings. Further essential features and advantages of the present invention will be revealed here in the drawings and the description thereof.

FIG. 1 shows a schematic illustration of a travel or recreational vehicle from the prior art in a top view;

FIG. 2 shows a cutout of a sanitary region of a motorhome, caravan or similar travel or recreational vehicle;

FIG. 3 shows a schematic detailed view of a toilet device in a front view;

FIG. 4 shows a schematic illustration of the toilet device, which is shown in FIG. 3, in a rear view;

FIG. 5 shows a further schematic illustration of a toilet device in a sectional view;

FIG. 6 shows a schematic illustration of the toilet device, which is shown in FIG. 5, in a side view;

FIGS. 7a to 7e show schematic illustrations of the functioning principle of a refinement of the toilet device;

FIGS. 8a to 8e show schematic illustrations of the functioning principle of a further refinement of the present invention;

FIG. 9 shows a schematic illustration of a further exemplary embodiment of a toilet device;

FIG. 10 shows a further schematic illustration of the toilet device shown in FIG. 9;

FIG. 11 shows a schematic illustration of a further exemplary embodiment of a toilet device;

FIG. 12 shows a schematic illustration of a further exemplary embodiment of a toilet device;

FIG. 13 shows a further illustration of the toilet device shown in FIG. 12;

FIG. 14 shows a further exemplary embodiment of a toilet device in a schematic illustration;

FIG. 15 shows a further exemplary embodiment of a toilet device in a schematic illustration;

FIG. 16 shows a further illustration of the toilet device shown in FIG. 15;

FIG. 17 shows a further exemplary embodiment of a toilet device in a schematic illustration;

FIG. 18 shows a further illustration of the toilet device shown in FIG. 17;

FIG. 19: shows a further illustration of the toilet device shown in FIG. 17;

FIG. 20 shows a further exemplary embodiment of a toilet device in a schematic illustration;

FIG. 21 shows a further illustration of the toilet device shown in FIG. 20;

FIG. 22 shows a further illustration of the toilet device shown in FIG. 20;

FIGS. 23a to 23c show further schematic illustrations of the toilet device shown in FIG. 11;

FIGS. 24a to 24c: show further schematic top view illustrations of the toilet device according to FIGS. 23a to 23c.

### DETAILED DESCRIPTION OF THE INVENTION

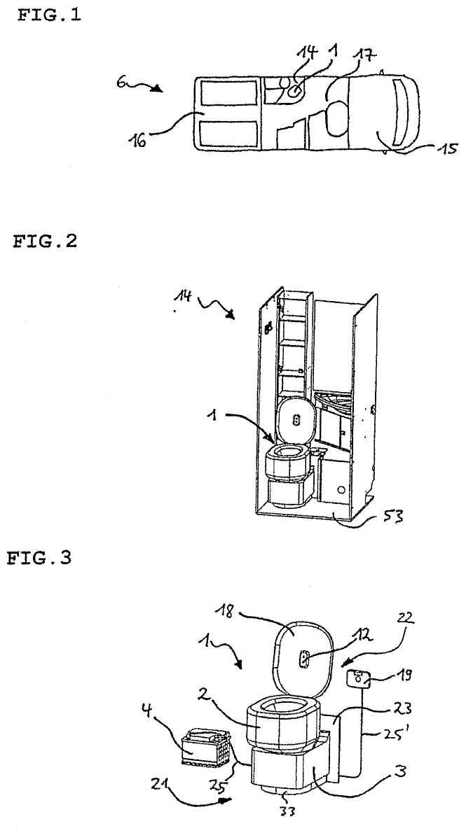

FIG. 1 illustrates a layout of a motorhome 6 in a schematic view. The motorhome 6 illustrated in a known manner comprises a driver's region 15, a sleeping region 16 and a living region 17. Depending on individual user requirements, deviations from the layout illustrated in FIG. 1 may also occur.

Furthermore, the motorhome 6 illustrated comprises a sanitary region 14. The sanitary region 14 comprises a toilet device 1 (also see FIG. 2).

In contrast to toilet devices from the prior art, in which flushing operations, for example, for eliminating excrement or other excretions, in particular, from the human body, are carried out by water, the toilet device 1 is connected to a power source 4 (see, for example, FIG. 3). The carrying out of flushing operations without using water is thereby made possible. A water-free flushing operation is, therefore, possible by use of the toilet device 1. This can also be worded in such a manner that excrement, excretions, etc. are eliminated without the use of water, i.e. in a water-free manner.

FIG. 3 shows a schematic illustration of a toilet device 1 by which a water-free flushing operation can be carried out. In the exemplary embodiment according to FIG. 3, the toilet device 1 comprises a seat element 2 and a collecting element 3. In the exemplary embodiment, the toilet device 1 furthermore comprises a cover 18 and a sensor 12 arranged in the cover 18. The present invention can also make provision for the toilet device 1 to comprise a cover 18 which does not comprise a sensor. The cover 18 is provided to cover the seat element 2. This is provided, in particular, whenever the toilet device 1 is not in use.

The current source 4 is illustrated schematically in FIG. 3 as a battery, for example, car battery. In a manner not illustrated specifically, the present invention can make provision for the toilet device 1 to be able to be connected to the current supply of the motorhome, caravan, etc., i.e. to the electrical system thereof.

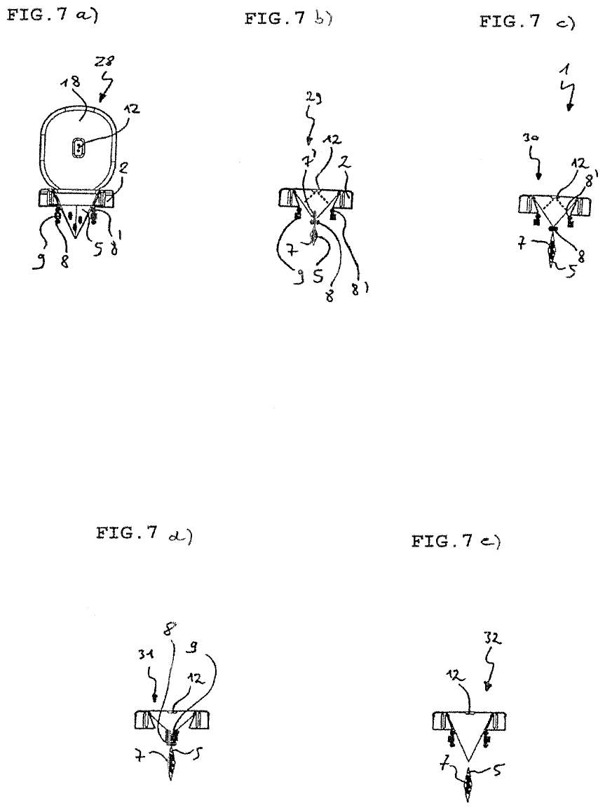

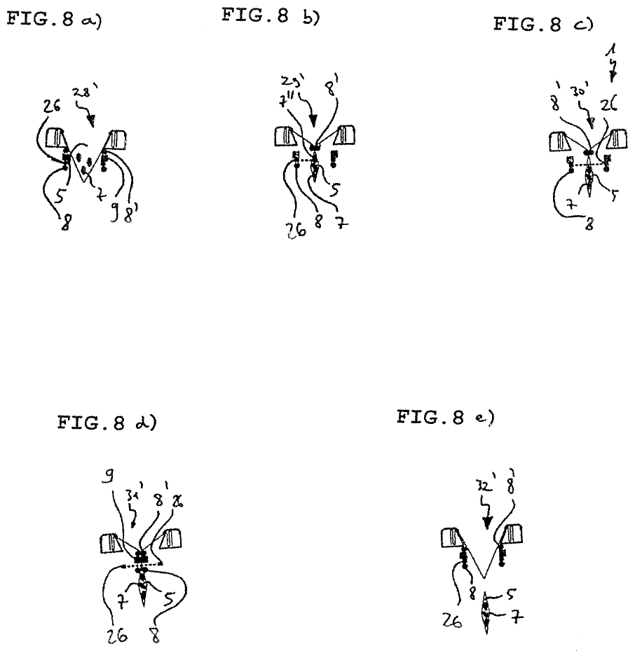

In the exemplary embodiment shown, the toilet device 1 is electrically connected via electric lines 25, 25′ both to the current source 4 and to an actuating mechanism 19. The toilet device 1 is operated here (also see FIGS. 7a to 7e and FIGS. 8a to 8e) via the actuating mechanism 19.

It is furthermore illustrated that the toilet device 1 comprises a stand mechanism 33. In a manner not illustrated specifically, the present invention can make provision for a control unit (also see FIG. 14 for this purpose) to be arranged in the stand mechanism 33, which control unit can be used to control the toilet device 1 or individual parameters for use of the toilet device 1.

The toilet device 1 illustrated in FIG. 3 comprises a mounting mechanism 23 which is arranged on a rear side 22. The mounting mechanism 23 makes it possible for the toilet device 1, for example, in a motorhome, to be able to be mounted, in particular, in a sanitary region 14 arranged in the latter. Within the context of the present invention, the mounting mechanism 23 can also be regarded as an installation frame.

In the exemplary embodiment, the sensor 12 comprises at least one camera and/or at least one LED.

The sensor 12 can be regarded as a means for detecting objects which makes it possible to detect objects which are located in a container 5 of the toilet device 1 (see, for example, FIG. 7a).

Provision can be made here for the sensor 12 to transmit sensed data to a control unit (see FIG. 14) which can permit or undertake corresponding control of the toilet device 1 depending on the data transmitted by the sensor 12.

The sensor 12, therefore, permits detection of objects which are located in a container (see, for example, FIG. 5). Such objects can be, for example, excrement, etc.

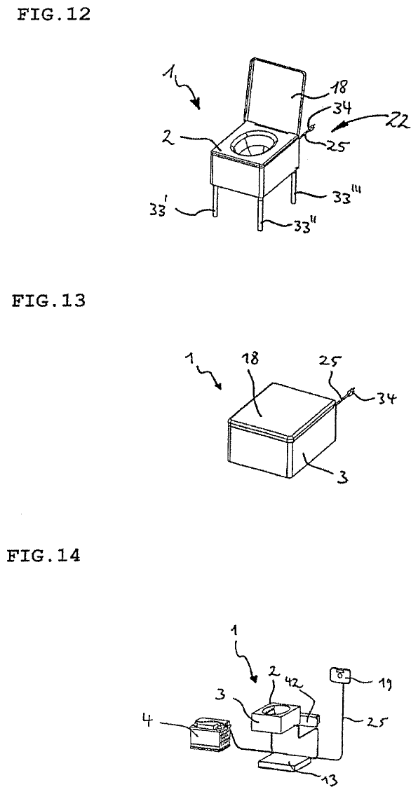

Within the context of the present invention, it can also be provided that the toilet device 1 comprises a plug (also see, for example, FIG. 12) which can be plugged into a socket of the motorhome, caravan, etc., in order to provide electrical current for the toilet device.

Within the context of the present invention, it can, therefore, be provided that the current source has voltages within the voltage range of 6 V to 24 V, preferably 12 V, or within the voltage range of 200 V to 230 V.

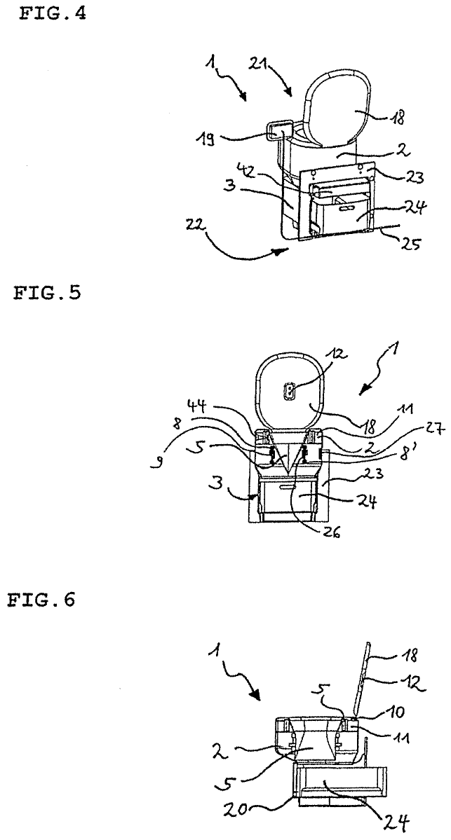

FIG. 4 shows a schematic illustration of the toilet device 1 in a rear view. It is apparent here that the toilet device 1 comprises a drawer 24. It is shown that the drawer 24 is arranged in the collecting element 3.

The present invention can, therefore, also make provision for the collecting element 3 of the toilet device 1 to comprise at least one drawer 24.

The toilet device 1 here is configured in such a manner that the drawer 24 can be inserted into and removed from the collecting element 3 or the toilet device 1 from a rear side 22. Within the context of the present invention, it can also be provided here that the rear side 22 is arranged on a wall (not shown specifically) of a motorhome, caravan, etc. The drawer 24 can, therefore, be inserted or removed in a manner known per se from an outer side through a flap of the motorhome, caravan, etc.

It is also apparent from FIG. 4 that the toilet device 1 comprises an energy store 42. In the exemplary embodiment, the energy store 42 is arranged on the rear side 22, in particular, for aesthetic reasons. The energy store 42 can also be regarded as an accumulator or battery.

FIG. 5 shows a schematic illustration of a toilet device 1 in a sectional view. It is apparent here that the toilet device 1 comprises at least one container 5. It is provided here that excrement or similar excretions 7 can be transferred into the collecting element 3 by the container 5 (also see, for example, FIGS. 7a to 7e or FIGS. 8a to 8e).

The present invention can also be regarded in such a manner that flushing or a flushing operation of the toilet device takes place by closing, in particular, bonding, of a container in which excrement or similar excretions are located.

In the exemplary embodiment, the seat element 2 comprises a receiving space 11. The container 5, in the form of a film tube, is arranged in the receiving space.

It is also apparent from FIG. 5 that the seat element 2 is designed as a receiving mechanism for the container 5.

Within the context of the present invention, it can be provided that the seat element 2 comprises a sensor 44. A sensor 44 of this type can sense, for example, whether sufficient amounts of containers 5 are available.

In the exemplary embodiment, the toilet device 1 comprises a sound generator 27 which is arranged in the seat element 2. The sound generator 27 can be understood as being a loudspeaker. The sound generator 27 can be provided in order for an acoustic signal to be output should the amount of containers 5 be sufficient only still for few uses of the toilet device 1.

Provision can be made for an acoustic warning signal to be output should a limit value predetermined by the user be reached or fallen short of. The sound generator 27 can, therefore, be understood to be a warning mechanism which promptly provides information regarding a low stock of containers 5. The user is, therefore, spared not being able to respond to a possible call of nature because a container 5 is no longer present.

It is also apparent from FIG. 5 that the toilet device 1 comprises closing mechanisms 8, 8′. The container 5 can be closed by the closing mechanism. With the context of the present invention, the closing mechanisms 8, 8′ can also be understood as being rollers. Within the context of the present invention, the closing mechanism 8 can be understood as being an upper roller and the closing mechanism 8′ as being a lower roller. Within the scope of the present invention, the closing mechanisms 8, 8′ can be designed in the manner of cylinders.

The closing mechanisms 8, 8′ can comprise a heating element 9. The container 5 can, therefore, be closed by heat. It can, therefore, be provided, for example, that the container 5 is composed of a plastics material which is completely closed by bonding by heat generated by the heating element 9. Possible contents of the container 5, for example, excrement, therefore, cannot escape from the container 5 after closing or bonding, etc. The present invention can also make provision for the closing mechanism to be designed as heating element.

Within the scope of the present invention, it is provided that at least closing mechanisms 8, 8′ and/or heating element 9 are controlled by a control unit (see FIG. 14).

In the exemplary embodiment, the toilet device 1 comprises at least one optoelectrical system 26 which can also be referred to as a light barrier and which is arranged in the seat element 2 below closing mechanisms 8, 8′ arranged in the seat element (also see FIGS. 7a to 7e and FIGS. 8a to 8e). Within the context of the present invention, the fact that the collecting element 3 is arranged below the seat element 2 can be used by way of explanation in this regard.

The present invention can also make provision for the toilet device 1 to comprise at least one optoelectrical system 26 which is arranged below at least one closing mechanism 8, 8′ and/or between two closing mechanisms 8, 8′.

The optoelectrical system 26 is arranged here below the closing mechanism 8 or between the closing mechanisms 8, 8′.

FIG. 6 shows a schematic illustration of the toilet device 1, which is shown in FIG. 5, in a side view. It can be seen that the toilet device 1 comprises a further sensor 20 which is arranged in a drawer 24. It can be sensed by the sensor 20 whether the drawer 24 is in a position which permits the receiving of a container 5 filled with excrement or similar excretions 7 (also see, for example, FIGS. 7a to 7e and FIGS. 8a to 8e).

Furthermore, it can be seen that the toilet device 1 comprises a cover 18. The cover 18 can also be understood as being a toilet lid. In the exemplary embodiment, the cover 18 is arranged in an articulated manner on the toilet device 1. For this purpose, the toilet device 1 comprises a hinge 10 which is connected or is connectable to the cover 18 and to the seat element 2.

In a manner not illustrated specifically, it can be provided within the scope of the present invention that the hinge 10 comprises a sensor which transmits data to a control unit (see, for example, FIG. 14), the data permitting conclusions to be drawn as to the position in which the cover 18 is located. In particular, it can be determined whether the cover 18 covers or does not cover the seat element 2.

In this connection, it can be offered by way of explanation that a cover 18 which covers the seat element 2 provides a state which can also be understood as being the inoperative state. The position of the cover 18 can have an effect in respect of the function of the sensor 12 arranged in the cover 18.

Schematic illustrations of the functioning principle of various refinements of a toilet device 1 are in each case presented in FIGS. 7a to 7e and 8a to 8e.

In this connection, it is illustrated in a first step 28 in FIG. 7a that excrement or similar excretions 7 is or are located in the container 5. It can be seen here that the cover 18 does not close the seat element 2. A situation of this type can exist, for example, when the toilet device 1 is in use or is in a use position.

In a second step 29 (FIG. 7b), the cover 18 covers the seat element 2 and, therefore, makes it possible for the sensor 12 which is arranged in the cover 18 to check whether objects, for example, excrement 7, are located in the container 5 and whether closing of the container 5 by use of the closing mechanisms 8, 8′ or of the heating element 9 is already possible.

It is illustrated in the second step 29 (FIG. 7b) that excrement 7 is located in the container 5 and that the closing mechanism 8 has already constricted or closed the container to such an extent that further excrement 7 can no longer enter the container 5. However, excrement 7′ is still present here above the closing mechanism 8 and is sensed by the sensor 12. The sensing is illustrated by way of indication by dashed lines. By opening of the closing mechanism 8, the excrement 7′ drops into the container 5 which, in a third step 30 (FIG. 7c), is illustrated again in a closed state.

In the third step 30 (FIG. 7c) all of the excrement is arranged within the container 5. The state illustrated in the third step 30 can be considered to be a complete flushing operation.

In the fourth step 31 (FIG. 7d), the container 5 which is already held by closing mechanism 8 is closed by the heating element 9. The heating element 9 here heats the container 5 which is manufactured from a plastics material.

It is furthermore illustrated in FIG. 7d that the two closing mechanisms 8, 8′ and the heating element 8 are arranged in a retracted state. In such a state, the container 5 is closed. This takes place here by a material bond of the container 5, which is designed as a film tube, by bonding by the heating element 9. By the two closing mechanisms 8, 8′ which are arranged above and below the heating element 9, firstly holding of the container 5 is made possible and secondly advancing of a further unused container 5 is made possible. This is also illustrated in an analogous manner in FIG. 8d.

The container 5 is, therefore, closed by heat, with the closing also being able to be understood as bonding. The container 5 is closed by a material bond. By such bonding of the container 5, very stable closing of the container 5 can be achieved, as a result of which it is also possible to prevent the container 5 from opening, for example, as it is being transported away and excrement 7 from being able to emerge from the container 5. Furthermore, in the fourth step (FIG. 7d), the container 5 which has been filled with excrement 7 and closed is detached. The container 5 is detached by the heating element 9. It can, therefore, be provided that the heating element 9 is designed as a separating mechanism.

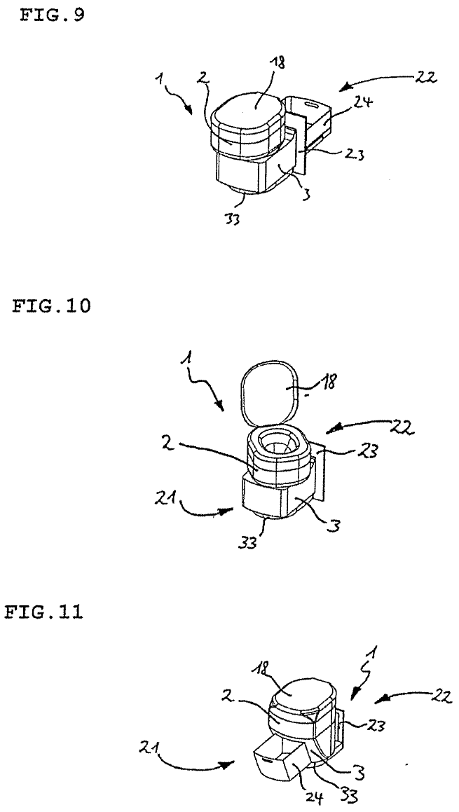

In a fifth step 32 (FIG. 7e), it is provided that the container 5 is transported away. The transporting away can take place, for example, into a collecting element (see, for example, FIG. 9).

Water-free flushing can therefore take place within the context of the present invention in such a manner that a container 5 in which excrement 7 is located is at least closed and is optionally transferred into a collecting element 3.

The present invention makes provision here for water-free flushing or closing of a container to take place by an electrical current. For this purpose, the toilet device comprises closing mechanism and/or heating mechanism.

The mentioned functioning principle of water-free flushing is also illustrated by way of example in FIGS. 8a to 8e. In a first step 28′ (FIG. 8a) excrement 7 passes into a container 5 which is designed as a film tube. A flushing operation then takes place in a such a manner that the container 5 is first of all closed. This takes place in a third step 30′ (FIG. 8c) by closing mechanism 8′. The container 5 is bonded by the heating element 9 (see fourth step 31′, FIG. 8d). The container 5 is subsequently detached by the heating element 9 (see fifth step 32′, FIG. 8e) and optionally transported away.

In the exemplary embodiment, the toilet device 1 comprises an optoelectrical system 26 which is designed as a light barrier. The optoelectrical system 26 is arranged between the heating element 9 and the closing mechanism 8′ (see, for example, FIG. 8b). The optoelectrical system 26 is arranged here below the heating element 9.

It can be sensed by the optoelectrical system 26 whether excrement, here excrement 7″, is arranged in the container 5 in such a manner that the container 5 as a result of the arrangement of the excrement 7″ cannot be completely closed, for example, by a heating element 9 (see second step 29′, FIG. 8b).

A state in which the container 5 can be completely closed is shown in the fourth step 31′ (FIG. 8d). It is also apparent here that, in the fourth step 31′, excrement 7 is completely arranged in the container 5 in such a manner that the optoelectrical system 26 cannot sense any excrement 7. Closing and optionally detaching of the container 5 by a material bond of the container 5 can therefore take place, with no excrement being located in the region to be closed. Particularly reliable closing of the container 5 is therefore made possible. In particular, it is possible to prevent the closed container 5 from being able to open (see FIG. 8e).

Further exemplary embodiments of the toilet device 1 are presented in FIGS. 9 to 11. Within the scope of the present invention, it can thus be provided that the collecting element 3 comprises a drawer 24 which is arranged on the rear side 22 of the toilet device 1. It is provided in this connection that the drawer 24 can be inserted or removed from an outer side of a motorhome, caravan, etc. through a flap (FIG. 9).

It can also be provided that a drawer is arranged on the front side 21 of the toilet device (FIG. 11). An arrangement of this type can permit the removal of a container filled with excrement (see, for example, FIG. 7) from an inner side of a motorhome, caravan, etc. In this case, a cutout in a wall of the motorhome, caravan, etc. is not necessary, and therefore production costs may possibly be reduced.

Within the scope of the present invention, it can also be provided that the seat element 2 is rotatable in relation to the collecting element 3 (FIG. 10). This can be of particular advantage particularly if space conditions are restricted.

In further refinements of the present invention according to FIGS. 12 and 13, it can be provided that the toilet device 1 comprises a plurality of stand mechanisms 33′, 33″, 33′″ which are designed here as foldable chair legs. In a folded-up state (FIG. 13), the toilet device 1 can also be stowed in a flexible and particularly space-saving manner outside a motorhome, caravan, etc. The embodiment according to FIG. 12 shows that the toilet device 1 does not absolutely have to have a collecting element. A toilet device 1 without a collecting element can be produced particularly cost-effectively and also permits a reduction in weight of the toilet device.

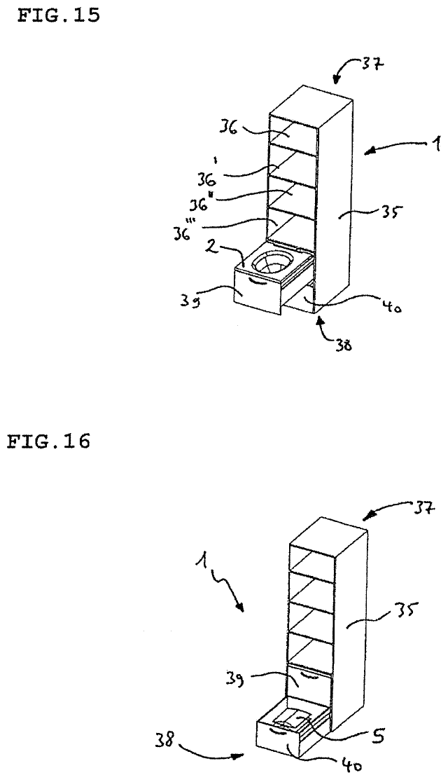

It is illustrated in further exemplary embodiments according to FIGS. 15 and 16 that the toilet device 1 is arranged in a cupboard 35 which is arranged in the sanitary region 14 (see FIG. 2). The cupboard 35 comprises a plurality of storage compartments 36, 36′, 36′″. The storage compartments 36, 36′ are arranged in a region of the upper side 37 of the cupboard 35.

The seat element 2 is arranged in an upper drawer element 39 of the cupboard 35 (see FIG. 15). In the present case, the toilet device according to FIG. 15 does not comprise a collecting element. The weight of the toilet device can thus be reduced.

The collecting element 3 can be arranged in a lower drawer element 40 (see FIG. 16). The two drawer elements 39, 40 can be pulled out when required. A highly space-saving toilet device is thus provided. The seat element 2 is preferably arranged on the lower side 38 of the cupboard 35.

The present invention can, therefore, make provision for the collecting element to be configured as a drawer of a cupboard.

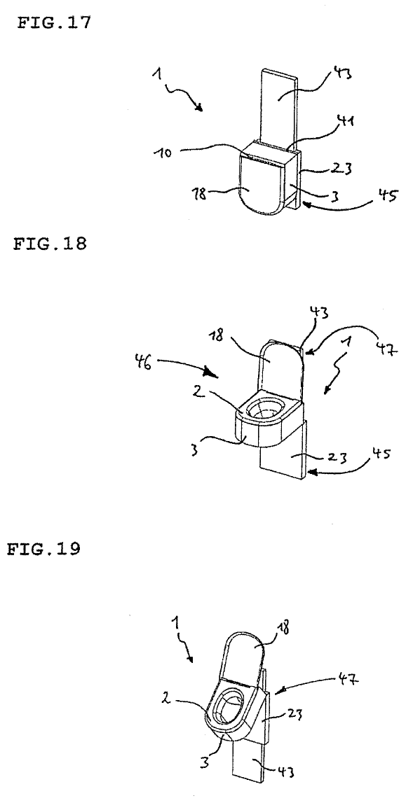

In further embodiments according to FIGS. 17 to 19, the toilet device 1 comprises at least one movement mechanism 43 by which the toilet device 1 is movable in a vertically displaceable manner.

In this connection, FIG. 17 illustrates a state in which the seat element 2 and the collecting element 3 are arranged in a lower region 45. The state can be understood as being the inoperative state. The toilet device 1 for this purpose is in a folded-up state. For this purpose, the collecting element 3 comprises a hinge 41 which is connectable to the movement mechanism 43.

In a first use position 46 (see FIG. 18), the toilet device 1 is movable along the movement mechanism 43. Depending on individual requirements, it is provided that the seat element 2 and the collecting element 3 are movable into positions which lie between the upper region 47 and the lower region 45. The first use position 46 is provided, in particular, in order for the toilet device 1 to be used when sitting. It is also possible for the toilet device 1 in a second use position 47 to be movable by a hinge 41 (see FIG. 17) in the direction of the lower region 45 and to be lockable. In such a second use position 47, it can be made possible for the toilet device 1 to be usable while standing.

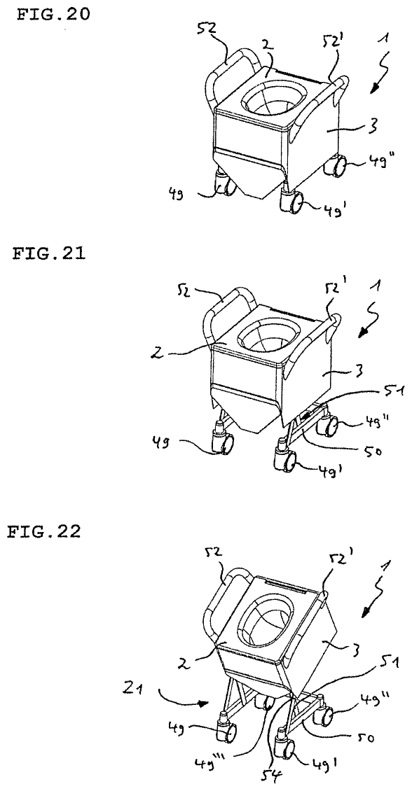

In a further exemplary embodiment, the toilet device 1 can comprise a framework 50 on which rollers 49, 49′, 49″ can be arranged (see FIGS. 20 and 21). The toilet device can thereby be rollable and can be used at or in different localities and therefore in a particularly flexible manner.

It can also be provided that the toilet device 1 comprises handles 52, 52′, onto which a user can hold. Such handles 52, 52′ can contribute to increased safety during or after use of the toilet device 1. For example, falling of a user can be avoided.

Furthermore, the toilet device 1 which comprises a framework 32 can be vertically displaceable in relation to the framework 32 and for this purpose can comprise a lifting device 51 (FIG. 21). The lifting device 51 can be designed as a scissors mechanism. In particular, the collecting element 3 or the seat element 2 can be vertically displaceable here. Individual needs of a user of the toilet device 1 can thereby be taken into consideration.

In a further refinement, the toilet device 1 can also comprise a framework 32 with rollers 49, 49′, 49″ and 49′″, and a lifting device 51 and, furthermore, a tilting device 54 (see FIG. 22). A toilet device 1 which is usable in a flexible manner can thereby be provided. In combination with handles 52, 52′, a toilet device 1 can also be provided with what is referred to as a standing aid which is required, for example, for physically disabled people.

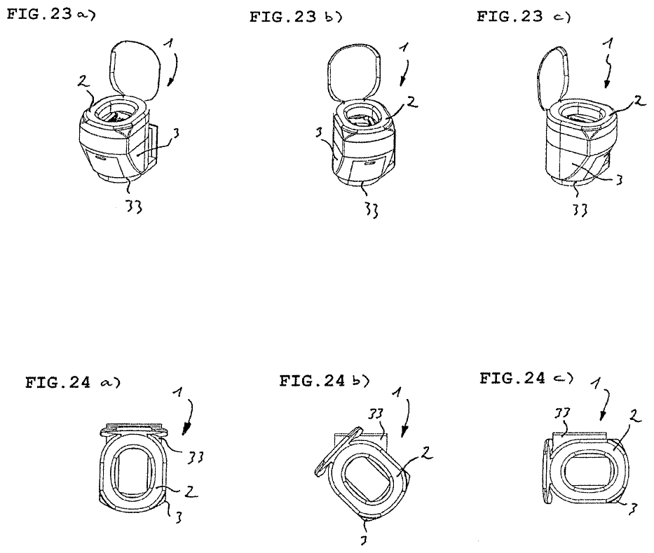

In a further refinement of the present invention according to FIGS. 23a to 23c, it can be provided that the toilet device 1 is designed to be rotatable in relation to a stand mechanism 33. In this connection, it can furthermore be provided that the seat element 2 and/or the collecting element 3 are or is rotatable in relation to the stand mechanism 33. Simplified accessibility to the toilet device 1, for example, in the event of restricted space conditions in the motorhome or in the sanitary region, can, therefore, be made possible.

The present invention can also make provision for the toilet device 1 to be rotatable in relation to the stand mechanism 33. In this case, rotations of the toilet device 1 at angles between up to 45° (FIG. 24b) or up to 90° (FIG. 24c) can be provided. The invention can also make provision for the toilet device 1 to be rotatable in relation to a floor 53 (FIG. 2).

The present invention can make provision for the toilet device to be rotatable in relation to a floor or in relation to a stand mechanism by angular ranges which lie between 10° and 135°, preferably 30° and 100°, particularly preferably between 45° and 90°. Such a rotatable toilet device can be used particularly flexibly.

### LIST OF REFERENCE SIGNS

1 Toilet device
2 Seat element
3 Collecting element
4 Current source
5 Container
6 Motorhome, caravan or similar travel or recreational vehicle
7 Excrement (or similar excretions)
7′, 7″ Excrement (or similar excretions)
8, 8′ Closing mechanism
9 Heating element
10 Hinge
11 Receiving space
12 Sensor
13 Control unit
14 Sanitary region
15 Driver's region
16 Sleeping region
17 Living region
18 Cover
19 Actuating mechanism
20 Sensor
21 Front side (of the toilet device)
22 Rear side (of the toilet device)
23 Mounting mechanism
24 Drawer element
25, 25′ Electric line
26 Optoelectrical system
27 Sound generator
28, 28′ First step
29, 29′ Second step
30, 30′ Third step
31, 31′ Fourth step
32, 32′ Fifth step
33, 33′ Stand mechanism
33″ Stand mechanism
33′″ Stand mechanism
34 Plug
35 Cupboard
36, 36′ Storage compartment
36″ Storage compartment
36′″ Storage compartment
37 Upper side (of the cupboard 35)
38 Lower side (of the cupboard 35)
39 Upper drawer element (of the cupboard 35)
40 Lower drawer element (of the cupboard 35)
41 Hinge
42 Energy store
43 Movement mechanism
44 Sensor
45 Lower region (of the movement mechanism 43)
46 First use position
47 Upper region (of the movement mechanism 43)
48 Second use position
49, 49′ Rollers
49″ Rollers
49′″ Rollers
50 Framework
51 Lifting device
52, 52′ Handle
53 Floor (of the sanitary region 14)
54 Tilting device

1. A motorhome, caravan or similar travel or recreational vehicle, comprising at least one sanitary region, in which a toilet device is arranged, wherein the toilet device comprises at least one seat element, wherein the toilet device is connected to a current source by which a water-free flushing operation can be carried out.

2. The motorhome, caravan or similar travel or recreational vehicle as claimed in claim 1, wherein the toilet device comprises at least one collecting element.

3. The motorhome, caravan or similar travel or recreational vehicle as claimed in claim 1, wherein the toilet device comprises at least one container by which excrement or similar excretions can be transferred into the collecting element.

4. The motorhome, caravan or similar travel or recreational vehicle as claimed in claim 1, wherein the toilet device comprises at least one closing mechanism by which the at least one container can be closed.

5. The motorhome, caravan or similar travel or recreational vehicle as claimed in claim 4, wherein the at least one closing mechanism comprises at least one heating element, wherein preferably the at least one closing mechanism and the at least one heating element are designed as an integral assembly.

6. The motorhome, caravan or similar travel or recreational vehicle as claimed in claim 1, wherein the toilet device comprises at least one optoelectrical system which is preferably arranged in the seat element below a closing mechanism arranged in the seat element.

7. The motorhome, caravan or similar travel or recreational vehicle as claimed in claim 1, wherein the current source is electrically connected to the closing mechanism and/or to the heating element.

8. The motorhome, caravan or similar travel or recreational vehicle as claimed in claim 5, wherein the closing mechanism and/or the heating element are/is designed as a separating mechanism for the container which is preferably manufactured from a plastic and is designed in particular as a film tube.

9. The motorhome, caravan or similar travel or recreational vehicle as claimed in claim 1, wherein the seat element is designed as a receiving mechanism for the at least one container.

10. The motorhome, caravan or similar travel or recreational vehicle as claimed in claim 1, wherein the toilet device comprises at least one sensor which is preferably arranged in a cover.

11. The motorhome, caravan or similar travel or recreational vehicle as claimed in claim 1, wherein the seat element is rotatable and/or pivotable in relation to the collecting element.

12. The motorhome, caravan or similar travel or recreational vehicle as claimed in claim 1, wherein the toilet device comprises at least one control unit and an actuating mechanism, wherein the control unit is electrically connected to the actuating mechanism and to the current source.

13. The motorhome, caravan or similar travel or recreational vehicle as claimed in claim 1, wherein the sanitary region comprises at least one cupboard, wherein the toilet device is arranged in the cupboard.

14. The motorhome, caravan or similar travel or recreational vehicle as claimed in claim 1, wherein the toilet device comprises at least one movement mechanism by which the toilet device is movable in a vertically displaceable manner.

15. The motorhome, caravan or similar travel or recreational vehicle as claimed in claim 1, wherein the toilet device comprises at least one energy store.

16. The motorhome, caravan or similar travel or recreational vehicle as claimed in claim 1, wherein the collecting element comprises a drawer, wherein the collecting element or the drawer comprises at least one sensor.

17. The motorhome, caravan or similar travel or recreational vehicle as claimed in claim 1, wherein the toilet device comprises at least one sound generator which is preferably arranged in the seat element.

18. The motorhome, caravan or similar travel or recreational vehicle as claimed in claim 1, wherein the toilet device is rotatable in relation to a floor or in relation to a stand mechanism by angular ranges which lie between 10° and 135°, preferably 30° and 100°, particularly preferably between 45° and 90°.
